(19) United States
(12) Patent Application Publication
(10) Pub. No.: US 2007/0066125 A1
(43) Pub. Date: Mar. 22, 2007

(54) Flat flexible cable clip with locating feature

(76) Inventors: Ralph Uenver, Netzbach (DE); Frank Eberhardt, Ditzingen (DE); Earl J. Hayes, South Lyon, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/231,237

(22) Filed: Sep. 20, 2005

(51) Int. Cl. H01R 13/58

(52) U.S. Cl. 439/459

(57) ABSTRACT

A clip for a flat flexible cable includes a first closure member having a top surface, a bottom surface and a side surface, a second closure member having a top surface, a bottom surface and a side surface, and a hinge member for hingedly connecting the first and second closure members. The clip includes a locating feature for locating the clip and preventing movement of the clip relative to the flat cable. In one embodiment, the locating feature comprises a post extending from a surface of the one of the first and second closure members that is received in an aperture in the flat cable. In another embodiment, the locating feature comprises one or more nibs projecting from the side surfaces of the clip that are received in cutouts formed in the side walls of the flat cable.

### TECHNICAL FIELD

The present invention generally relates to a retainer or clip for a flat flexible cable, and in particular to a clip that can be positioned at a desired location along the cable with a locating feature for preventing movement of the cable when the clip is positioned at a desired location along the cable.

### BACKGROUND OF THE INVENTION

Conventional methods for attaching wire harnesses to a vehicle body require a troublesome process for binding a wire harness clip to the wire harness. Typically, the wire harness and the wire harness clip are bound together by adhesives, such as tape wrap. As a result, the location of the clip is not adjustable along the wire harness. Consequently, the wire harness and the wire harness clip may not be properly aligned with the corresponding apertures in the vehicle body. The result is that the wire harness and the wire harness clip may not be properly mounted to the vehicle body, or in some extreme cases, the wire harness and wire harness clip may not be able to be mounted at all to the vehicle body.

### SUMMARY OF THE INVENTION

The inventors of the present invention have recognized these and other problems associated with the wire harness clips. To this end, the inventors have invented a clip for a flat, flexible cable comprising a first closure member having a top surface and a bottom surface, a second closure member having a top surface and a bottom surface, a hinge member for hingedly connecting the first and second closure members, and a locating feature for preventing movement of a flat cable when said clip is placed in a closed position.

In one embodiment, the locating feature comprises a first closure member having a top surface and a bottom surface, a second closure member having a top surface and a bottom surface, a hinge member for hingedly connecting the first and second closure members, and a locating feature for preventing movement of a flat cable relative to said clip when said clip is placed in a closed position.

In another aspect of the invention, a clip for a flat cable comprises a first closure member having a top surface and a bottom surface, a second closure member having a top surface and a bottom surface, a hinge member for hingedly connecting the first and second closure members, a post extending from one of said first and second closure members, and an aperture in the other one of said first and second closure members capable of receiving said post, wherein said post and said aperture, in combination, define a locating feature for preventing movement of a flat cable relative to said clip when said clip is placed in a closed position.

In yet another aspect of the invention a clip for a flat cable comprises a first closure member having a top surface and a bottom surface, a second closure member having a top surface and a bottom surface, a hinge member for hingedly connecting the first and second closure members, a nib extending from a sidewall of one of said first and second closure members, and a cutout located in said flat cable, wherein said nib and said cutout, in combination, define a locating feature for preventing movement of a flat cable relative to said clip when said clip is placed in a closed position.

### BRIEF DESCRIPTION OF THE DRAWINGS

FIG. 1 is a perspective view of a clip when in an open position for receiving a flat flexible cable according to an embodiment of the invention.

FIG. 2 is another perspective view of the clip shown in FIG. 1.

FIG. 3 is a side view of the clip shown in FIG. 1.

FIG. 4 is a perspective view of a clip when in a closed position according to another embodiment of the invention.

FIG. 5 is a side view of the clip of FIG. 4 when in the closed position according to an embodiment of the invention.

FIG. 6 is an enlarged view of the clip indicated by the circled area in FIG. 5.

FIG. 7 is a cross-sectional view of the clip taken along line 7-7 of FIG. 5.

### DETAILED DESCRIPTION

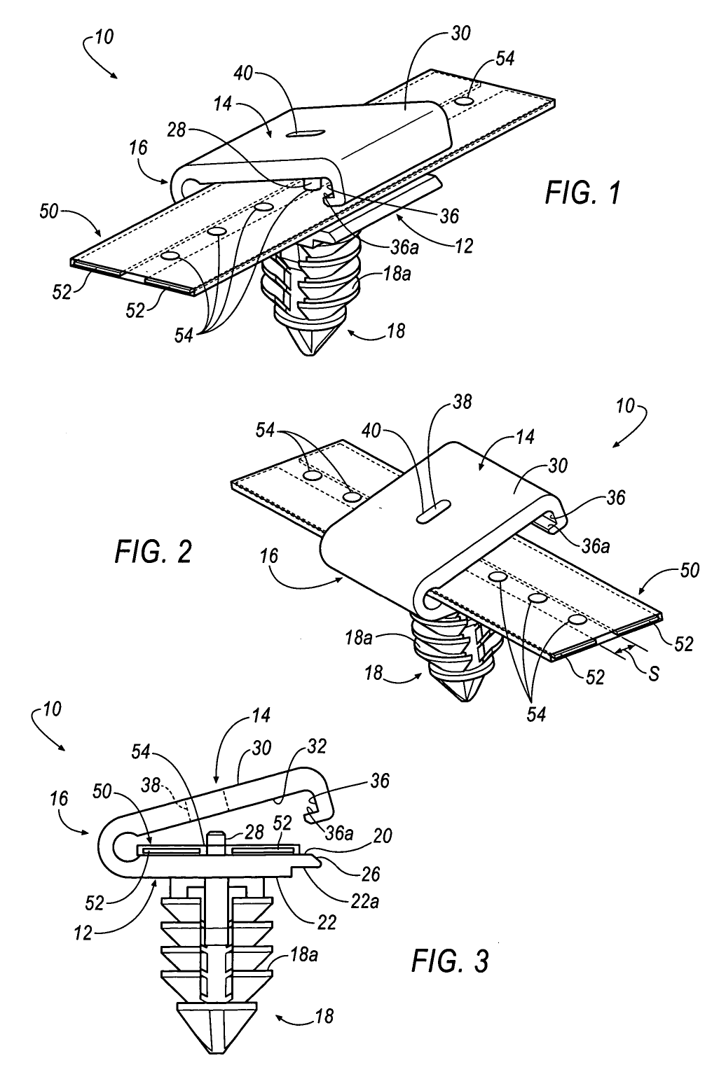

Referring to FIGS. 1-3, a retainer or clip for a flat flexible cable is generally shown at 10 according to an embodiment of the invention. In general, the clip 10 comprises a first closure member 12 and a second closure 14 member connected by a hinge member 16. The hinge member 16 may have a smaller thickness than the first and second closure members 12, 14, thereby forming a living hinge, or the like, for allowing the first and second closure members 12, 14 to hinge relative to one another. In the illustrated embodiment, the first closure member 12, the second closure 14 and the hinge member 16 are integrally formed as a single piece. The clip 10 may be formed from any number of non-conducting materials, such as, for example, polypropylene, polyamide, or the like.

As illustrated, the clip 10 also includes a retaining member 18 similar to a conventional “Christmas tree” retainer, as is known in the art. The retaining member 18 comprises a plurality of truncated flat surfaces 18a generally forming the shape of a cone. It will be apparent to those skilled in the art that the retaining member 18 may be substituted with any other type of mounting clip, stud and other known equivalents can be used. For example, the retaining member 18 may comprise an adhesive, tape, or the like. In the illustrated embodiment, the retaining member 18 is centrally located on the first closure member 12. However, it will be appreciated that the retaining member 18 can be located at any desirable location on the clip 10, such as, for example, on the second closure member 14.

The first closure member 12 includes a top surface 20, a bottom surface 22 and a side surfaces 26. The bottom surface 22 may have a substantially planar surface. However, the invention is not limited by the profile of the bottom surface 22. The bottom surface 22 includes a ledge 22a formed in one end of the bottom surface 22. The side surface 26 is angled with respect to the top and bottom surfaces 20, 22. A post 28 extends outwardly from the top surface 20 of the first closure member 12. The post 28 is generally circular in cross-sectional shape and has a diameter that is generally less than the space, S, between the conductors of a flat cable, shown generally at 50. For example, the diameter of the post 28 may be approximately 1.5 mm and the space, S, between conductors 52 of the flat cable 50 may be approximately 2.2 mm. It will be appreciated that the space, S, may vary depending on the width of the flat cable 50. As illustrated, the flat cable 50 includes a pair of conductors 52. However, it will be appreciated that the invention can be practiced with a flat cable having more than two conductors.

At least one aperture 54 is provided in the flat cable 50, and in combination with the post 28, provides a locating feature for the clip 10 such that when the post 28 is inserted through an aperture 54 of the flat cable 50, the clip 10 is positioned at a desired location along the flat cable 50. It will be appreciated that the flat cable 50 may include a plurality of apertures 54 to provide for several locations at which the clip 10 can be located along the flat cable 50.

The second closure member 14 includes a top surface 30, a bottom surface 32 and a side surfaces 36. The bottom surface 32 may have a substantially planar surface. However, the invention is not limited by the profile of the bottom surface 32. As seen in FIG. 3, the side surface 36 is generally C-shaped including a ledge 36a for engaging the ledge 22a of the first closure member 12 to retain the clip 10 in a closed position. The side surface 36 may be angled in a manner that is complimentary to the angled side surface 26 of the first closure member 12 so that the side surface 36 can easily engage the side surface 26 when snapping the clip 10 in the closed position.

As seen in FIGS. 1 and 2, the top surface 30 of the second closure member 14 includes a receiving recess 38 capable of receiving the post 28 extending from the top surface 20 of the first closure member 12. A thru-slot 40 may be formed in the top surface 30 of the second closure member 14 to accommodate relative rotational or twisting movement between the first and second closure members 12, 14 of the clip 10 to allowing the post 28 to enter the recess 38. It will be appreciated that the recess 38 and thru-slot 40 may be located at any desirable location that is complementary to the post 28. For example, the post 28 may be located toward an outer periphery of the top surface 20 of the first closure member 12, and therefore, the recess 38 and the thru-slot 40 would be located directly opposite the post 28 toward the outer periphery of the bottom surface 32 of the second closure member 14.

In operation, the flat flexible cable 50 is placed over the first closure member 12 when the clip 10 is in an open position such that the aperture 54 in the cable 50 is aligned with the post 28 of the clip 10. Then, the post 28 is inserted through the aperture 54 in the cable 50 to locate the clip 10 at the desired location on the cable 50 as shown in FIG. 1-3. In this manner, the post 28, in conjunction with the aperture 54 in the cable 50, acts as a locating feature for the clip 10. It will be appreciated that the cable 50 can be provided with a plurality of apertures 54 along its length to provide several locations at which the clip 10 can be located. Then the first and second closure members 12, 14 are hinged about the hinge member 16 until the ledge 36a of the second closure member 14 engages the ledge 22a of the first closure member 12 to place the clip 10 in a closed position. When the clip 10 is in the closed position, the first and second closure members 12, 14 are in an interlocking relationship with each other. In addition, it will be appreciated that when the post 28 is received in the aperture 54, the cable 50 is prevented from movement relative to the clip 10, thereby preventing movement of the cable 50 and maintaining the clip 10 at the desired location along the cable 50. It will be appreciated that the first and second members 12, 14 of the clip 10 have a sufficient width to allow the cable 50 to be placed on the first member 12 and to be hinged about the hinge member 16 without interference by the cable 50.

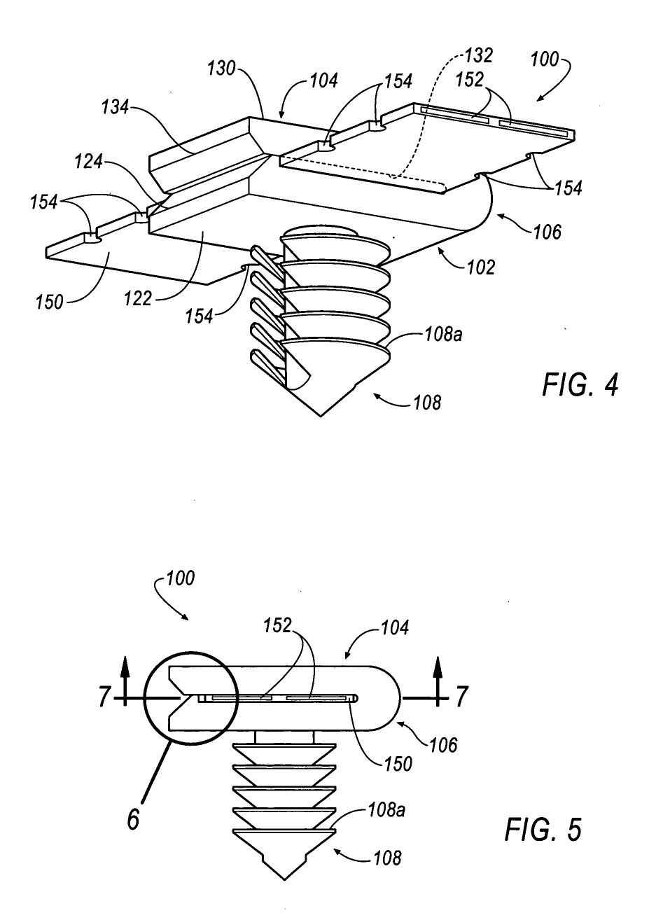

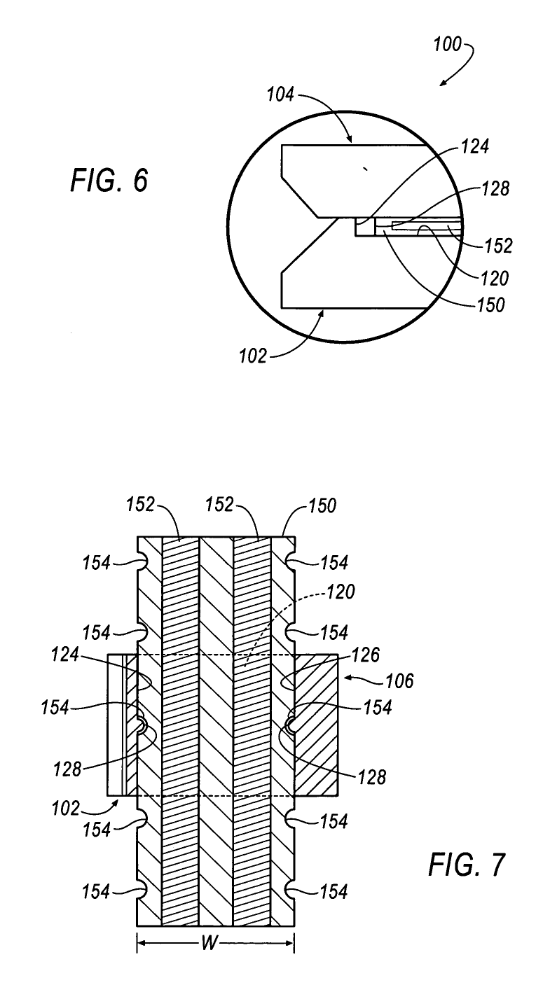

Referring now to FIGS. 4-7, a clip 100 with a locating feature is shown according to another embodiment of the invention. Similar to the clip 10, the clip 100 includes a first closure member 102, a second closure member 104 connected by a hinge member 106. The hinge member 106 may have a smaller thickness than the first and second closure members 102, 104, thereby forming a living hinge, or the like, for allowing the first and second closure members 102, 104 to hinge relative to one another. In the illustrated embodiment, the first closure member 102, the second closure 104 and the hinge member 106 are integrally formed as a single piece. The clip 100 may be formed from any number of non-conducting materials, such as, for example, polypropylene, polyamide, or the like.

As illustrated, the clip 100 also includes a retaining member 108 similar to a conventional “Christmas tree” retainer, as is known in the art. The retaining member 108 comprises a plurality of truncated flat surfaces 108a generally forming the shape of a cone. It will be apparent to those skilled in the art that the retaining member 108 may be substituted with any other type of mounting clip, stud and other known equivalents can be used. For example, the retaining member 108 may comprise an adhesive, tape, or the like. In the illustrated embodiment, the retaining member 108 is centrally located on the first closure member 102. However, it will be appreciated that the retaining member 108 can be located at any desirable location on the clip 100, such as, for example, on the second closure member 104.

The first closure member 102 includes a top surface 120, a bottom surface 122 and sidewalls or side surfaces 124, 126. The bottom surface 122 may have a substantially planar surface. However, the invention is not limited by the profile of the bottom surface 122. The side surfaces 124, 126 are separated by a width, W, approximately equal to a width of a flat cable 150. For example, the width, W, may be approximately 11.0 mm. The flat cable 150 includes a pair of conductors 152 and at least one pair of cutouts 154 formed in the side surfaces of the cable 150. At least one of the side surfaces 124, 126 includes a rib limiter or projecting nib 128 that cooperates with the at least one cutout 154 of the cable 150. The combination of the rib limiter or projecting nib 128 and the cutout 154 provides a locating feature for the clip 100. In the illustrated embodiment, the rib limiter or projecting nib 128 is provided on each side surface 124, 126 opposite each other. However, it will be appreciated that the flat cable 150 can be provided with a plurality of pairs of cutouts 154 disposed substantially opposite each other along the flat cable 150, thereby providing a plurality of locations at which the clip 100 may be located along the flat cable 150. In addition, it is not necessary that the nibs 128 and corresponding cutouts 154 be provided opposite each other, and that the invention can be practiced with a pair of cutouts 154 that are offset from each other. As illustrated, the flat cable 150 includes a pair of conductors 152. However, it will be appreciated that the invention can be practiced with a flat cable having more than two conductors.

The second closure member 104 includes a top surface 130, a bottom surface 132 and sidewalls or side surfaces 134, 136. The bottom surface 132 may have a substantially planar surface. However, the invention is not limited by the profile of the bottom surface 132.

In operation, the flat flexible cable 150 is placed on the top surface 120 of the first closure member 102 when the clip 100 is in an open position such that the cutouts 154 in the cable 150 are aligned with the nibs 128 of the clip 100. It will be appreciated that the cable 150 may be provided with a plurality of cutouts 154 to allow the clip 150 to be located at a plurality of locations along the cable 150. Then, the first and second closure members 102, 104 are hinged about the hinge member 106 until the first and second closure members 102, 104 are snapped together to place the clip 100 in a closed position. When the clip 100 is in the closed position, the cable 150 is prevented from movement relative to the clip 100, thereby preventing movement of the cable 150 and maintaining the clip 100 at the desired location along the cable 150.

The embodiments disclosed herein have been discussed for the purpose of familiarizing the reader with novel aspects of the invention. Although preferred embodiments of the invention have been shown and described, many changes, modifications and substitutions may be made by one having ordinary skill in the art without necessarily departing from the spirit and scope of the invention as described in the following claims.

1. A clip for a flat cable, comprising:
a first closure member having a top surface and a bottom surface;
a second closure member having a top surface and a bottom surface;
a hinge member for hingedly connecting the first and second closure members; and
a locating feature for preventing movement of a flat cable relative to said clip when said clip is placed in a closed position.

2. The clip according to claim 1, wherein said locating feature comprises a post extending from one of said first and second closure members, and an aperture in the other one of said first and second closure members capable of receiving said post.

3. The clip according to claim 2, wherein said clip is positioned at a desired location by inserting said post through the aperture formed in said cable.

4. The clip according to claim 1, wherein said locating feature comprises a nib extending from a sidewall of one of said first and second closure members, and a cutout located in said flat cable.

5. The clip according to claim 4, wherein said clip is positioned at a desired location by inserting said nib into said cutout formed in said flat cable.

6. The clip according to claim 1, further comprising a retaining member extending outwardly from one of said first and second closure members.

7. A clip for a flat cable, comprising:
a first closure member having a top surface and a bottom surface;
a second closure member having a top surface and a bottom surface;
a hinge member for hingedly connecting the first and second closure members;
a post extending from one of said first and second closure members; and
an aperture in the other one of said first and second closure members capable of receiving said post,
wherein said post and said aperture, in combination, define a locating feature for preventing movement of a flat cable relative to said clip when said clip is placed in a closed position.

8. The clip according to claim 7, wherein said clip is positioned at a desired location by inserting said post through the aperture formed in said cable.

9. The clip according to claim 7, further comprising a retaining member extending outwardly from one of said first and second closure members.

10. A clip for a flat cable, comprising:
a first closure member having a top surface and a bottom surface;
a second closure member having a top surface and a bottom surface;
a hinge member for hingedly connecting the first and second closure members;
a nib extending from a sidewall of one of said first and second closure members; and
a cutout located in said flat cable,
wherein said nib and said cutout, in combination, define a locating feature for preventing movement of a flat cable relative to said clip when said clip is placed in a closed position.

11. The clip according to claim 10, wherein said clip is positioned at a desired location by inserting said nib into said cutout formed in said flat cable.

12. The clip according to claim 10, further comprising a retaining member extending outwardly from one of said first and second closure members.
